(19) United States
(12) Patent Application Publication
(10) Pub. No.: US 2003/0178349 A1
(43) Pub. Date: Sep. 25, 2003

(54) Down pipe filter

(76) Inventors: Edward Dudley Bacon, Brackley (GB); John Richard Mirfin, Brackley (GB)

Correspondence Address: Paul E. Milliken, Patent and Trademark Attorney, 9061 Wall Street, NW, Massillon, OH, 44646-1676, US

(21) Appl. No.: 10/105,144

(22) Filed: Mar. 25, 2002

(51) Int. Cl. B01D 35/02

(52) U.S. Cl. 210/94; 210/232; 210/448; 210/497.3

(57) ABSTRACT

A filter assembly (10) for guttering down pipe (12) comprising a hollow body (13) having an internal base (24) and a conical filter (14) located within the body above the base and through which all the water must pass. The body (12) having a pair of opposed couplings (18, 21) for connection into a down pipe (12) and the filter (14) is arranged with its apex directed upwardly in use.

### FIELD

This invention relates to filters particularly for use in the down pipes or drain pipes for rain water gutters.

### BACKGROUND OF THE INVENTION

Rain water gutters as used just below the eaves of roofing frequently fill with leaves, silt, moss and other debris which is collected on a roof and then washed into the guttering by the rain water. The silt and leaves may then be washed into the down pipe where the lower portions of the pipe may become blocked. This is a particularly bad problem where the down pipe extends directly into an under soil soak-away and any blockage may only be detected when the pipe is full and water flows out through higher joints in the pipe, which may cause problems with damp and brickwork.

A known partial solution to the problem is to cover the upper mouth the down pipe, where it links with the gutter, with mesh so as to prevent leaves from entering the down pipe. This does not prevent silt from entering the down pipe to prevent accumulations of silt from building up within the pipe, and requires that maintenance to remove trapped leaves is effected at the guttering which is not always convenient, and may not always take place when the pipe is blocked, since it is not generally easily observable.

The present invention provides a filter assembly which can be fitted to the down pipe at a convenient level to facilitate maintenance at ground level.

### STATEMENTS OF THE INVENTION

According to the present invention there is provided a guttering down pipe filter comprising a hollow body having a pair of opposed couplings for connection into a down pipe and an internal base on which a water filter located within the body above the base and through which all the water must pass, the filter being substantially conical in shape with the apex directed upwardly in use.

Having the filter located above the base ensures that most silt is collected on the base before the water passes through the filter located above the base.

The filter may comprise wire mesh deformed to the required shape, a coarse open cell foam, porous sheet metal formed into a cone, or a hollow moulded plastic cone having a plurality of through holes or apertures formed in its surface.

The filter sits on the base of the body and preferably has a non porous portion adjacent said base. This allows silt or other debris to collect on the base in the space between the non porous portion and the body wall.

The body is preferably a cylindrical body comprising upper and lower telescopically interengaging body portions, each having one of said couplings formed at its free end with the filter being formed integrally with the lower body portion, preferably the filter and body portion are formed as a single plastics moulding.

Said couplings in use comprise upper and lower cylindrical couplings which telescopically engage with oppositely extending portions of the down pipe, the lower coupling engaging within the down pipe and including an outer concentric cylindrical skirt which surrounds the adjacent portion of down pipe. This helps mask the otherwise exposed end of the pipe. The upper coupling slides over the external surface of the respective portion of down pipe. The upper coupling may include a radial screw which in use secures the filter assembly to the respective portion of down pipe.

At least a portion of said body, preferably the lower body portion, is formed from a transparent material allowing the filter to viewed from outside the assembly. The lower body portion may be moulded from a suitable transparent plastics material such as PET ( polyethyleneteraphthallate), polycarbonate, PVC, etc.

### DESCRIPTION OF THE DRAWINGS

The invention will be described by way of example and with reference to the accompanying drawings in which:

FIG. 1 is a schematic sectional view of a filter assembly according to the present invention,

FIG. 2 is sectional view of a filter used in the assembly of FIG. 1.

FIG. 3 is side elevation of an alternative filter,

FIG. 4 is a bottom view of the filter of FIG. 3, and

FIG. 5 is a section on the line V-V in FIG. 3 showing the overlapping frustoconical portions of the filter.

### DETAILED DESCRIPTION OF THE INVENTION

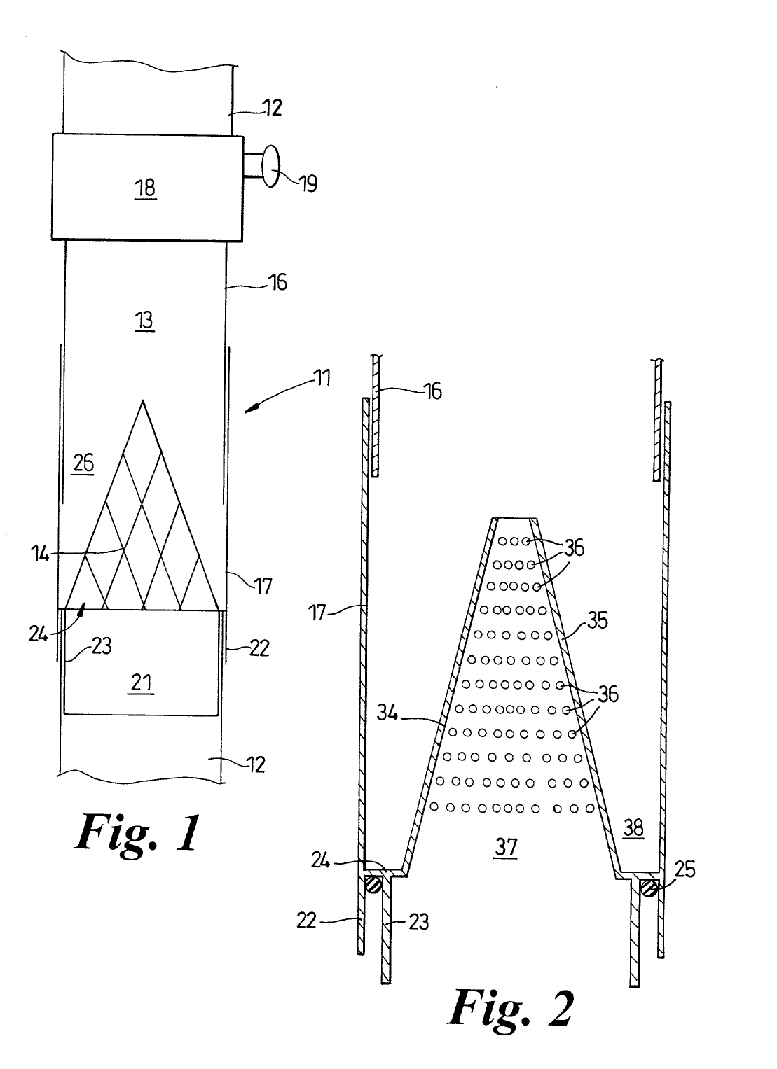

With reference to FIG. 1, there is shown in schematic form a filter assembly 11 for use with guttering down pipe 12 as is used with rain water guttering commonly fitted under the eaves of rooves.

The filter assembly 11 comprises a hollow cylindrical body 13 housing a filter 14. The filter 14 is conical in form and is secured within the body 13 with its apex pointing upwards in use. The filter 14 is a coarse filter suitable for stopping leaves and may be shaped by deforming wire mesh. Alternatively, as shown in FIG. 2, the filter 34 may be a hollow cone 35 having spaced holes 36 (about 3 mm-6 mm in diameter) passing through its shell.

The body 13 comprises two telescopic parts 16 & 17, the upper cylindrical part 16 being sealingly slidable within the lower cylindrical part 17.

The upper part 16 has a coupling 18 formed at its upper end which in use sealingly slides over the outer surface of a respective portion of down pipe 12. The upper part 16 may be held in place on the down pipe by a radial screw 19.

The lower part 17 has a coupling 21 formed at its lower end which has an inner portion 23 which in use slides within a portion of respective down pipe 12. The coupling 21 also includes an outer concentric skirt 22 radially spaced from the inner portion 23 and which in use masks an end portion of down pipe 12. An annular seal 25 ( see FIG.2) may be located within the radial space between the skirt 22 and inner portion 23.

The filter 14 sits on the base 24 of the lower body portion 17, and any leaves and/or debris collect in the space 26 formed between the filter 14 and the cylindrical sidewalls of the body 13. The porous portion of the filter 14 is preferably raised above the base 24 as is best seen in FIG.2 in which the holes 36 of the hollow conical filter 34 are spaced from the base 24 by an impervious rim 37. This allows silt to collect in the space 38 between the rim 37 and the inner side wall of the lower body portion 17.

The filter 34, base 24, and lower body portion 17 may be formed as a single moulding, or may be assembled from a plurality of individual parts. The lower body portion 17 is preferably moulded from a transparent thermoplastic material allowing the state of the filter to be observed from outside of the filter assembly without removal of the assembly from the down pipe. This should prevent un-necessary maintenance and warn of impending blockages.

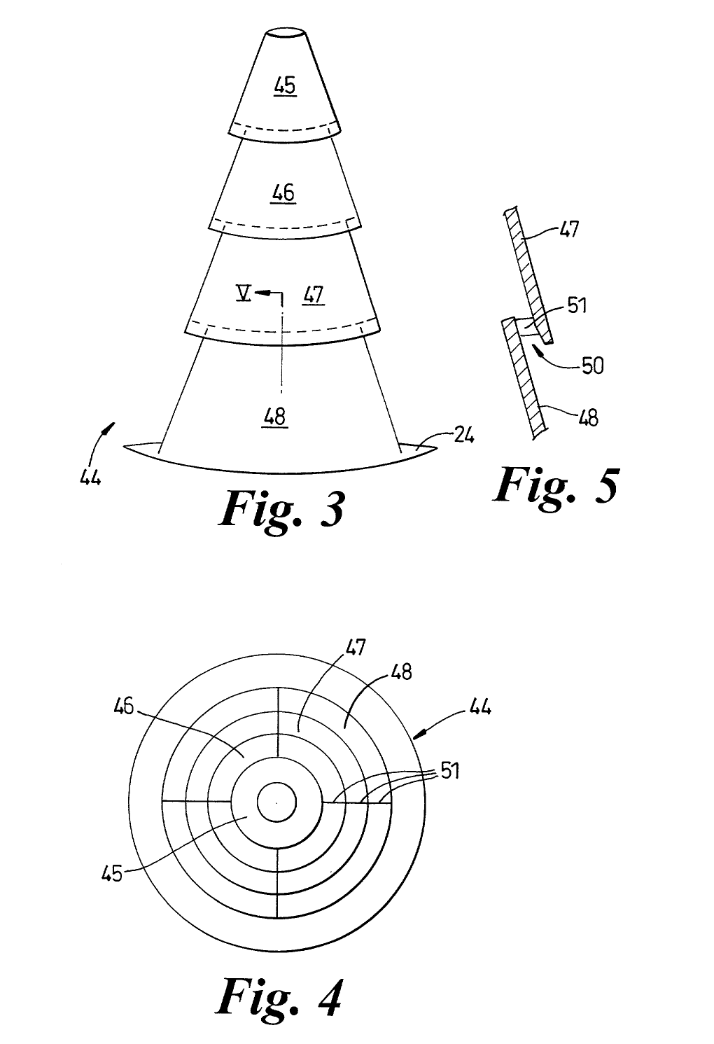

Yet another filter 44 is shown in FIGS. 3-5. The filter 44 is a thermoplastics moulding comprising a plurality of frustoconical portions of progressively different sizes, sitting one upon another, preferably four portions 45,46,47,48. The portions 45-48 are substantially impervious to water and each overlap with the respective adjacent portions so that there is an annular gap 50 between pairs of overlapping portions. Overlapping adjacent portions 48,47: 47,46: 46,45 are connected through a plurality of equiangularly spaced thin bridges 51. The bridges in this case are aligned with each other but could be arranged in other ways. The bridges 51 divide the annular gaps 50 into arcuate apertures through which the water will flow. The bottom frustoconical portion 48 spaces the first gap 50 from the base 24 to ensure that debris collects in the space 38 as previously described. The overlap of each gap 50 by the adjacent higher frustoconical portion prevents debris from flowing through the apertures and directs debris to the base 24.

If a blockage occurs, or during preventive maintenance, the filter assembly is simply removed from the down pipe and dis-assembled for cleaning.

1. A guttering down pipe filter assembly comprising a hollow body having a pair of opposed couplings for connection into a down pipe and a base, a filter located within the body above the base and through which all the water must pass, the filter being substantially conical in shape with its apex directed upwardly in use.

2. A filter assembly as claimed in claim 1 wherein the filter is substantially in the form of a hollow cone with a plurality of through holes dispersed over the surface.

3. A filter assembly as claimed in claim 2 wherein the filter comprises a plurality of frustoconical portions of progressively different sizes and arranged one on top the other, with apertures formed between overlapping portions.

4. A filter assembly as claimed in claim 2, wherein the filter sits on the base of the body and has a non porous portion adjacent said base.

5. A filter assembly as claimed in claim 1, wherein the body is a cylindrical body comprising upper and lower telescopically interengaging body portions, each having one of said couplings formed at its free end with the filter being secured in the lower body portion.

6. A filter assembly as claimed in claim 5 wherein the filter and lower body portion are a single plastics moulding.

7. A filter assembly as claimed in claim 1, wherein said couplings in use comprise upper and lower cylindrical couplings which telescopically engage with oppositely extending portions of down pipe, the lower coupling engaging within the down pipe and including an outer concentric cylindrical skirt which surrounds an adjacent portion of down pipe.

8. A filter assembly as claimed in claim 7 wherein the upper coupling slides over the external surface of a respective portion of down pipe.

9. A filter assembly as claimed in claim 8 wherein the upper coupling includes a radial screw which in use secures the filter assembly to the respective portion of down pipe.

10. A filter assembly as claimed in claims 1, wherein at least a portion of said body is formed from a transparent material allowing the filter to be observed.
